(19) United States
(12) Patent Application Publication
(10) Pub. No.: US 2011/0191186 A1
(43) Pub. Date: Aug. 4, 2011

(54) Method of autonomously recommending charging event of electric vehicle based on multiple factors and displaying carbon footprint data and personalized advertising via the vehicle display

(76) Inventors: Paul S. Levy, Chandler, AZ (US); Edward Butler, Gilbert, AZ (US); John C. Thomas, Beaverton, OR (US)

(21) Appl. No.: 12/699,863

(22) Filed: Feb. 3, 2010

(51) Int. Cl. G06Q 30/00; G06F 7/00; G06F 17/30; G06F 15/16; G06F 3/048

(52) U.S. Cl. 705/14.58; 701/29; 701/33; 705/14.4; 707/802; 709/227; 715/771; 707/E17.044; 715/810

(57) ABSTRACT

A method and system is provided in which a computer system within the Electrical Vehicle periodically connects to a remote database which recommends to the driver to start a charge event based on location and proximity to a charging station, discharge history, power capacity, power cost, time of day, and power generation means (e.g. solar vs. coal), as well as displaying vehicle carbon footprint data and dynamically delivered advertising.

### FIELD OF THE INVENTION

The present invention relates to the field of data autonomous decision recommendations based on preset and dynamic rules (i.e. carbon emissions of generation, cost per Kilowatt, location) as it relates to the cost of power used to re-charge Electrical Vehicles coupled to the present location and or future location of an Electric Vehicle. More specifically, the present invention relates to a method, apparatus, and system providing for the means to direct the driver to recharge their Electric Vehicle based on preset and dynamic based driving history coupled to opportunistic advertizing revenue cost offset, wherein advertising delivered to the Electric Vehicle is targeted based on user profile, behavioral and location data.

### BACKGROUND

As electrical vehicles enter mass production there is a desire to conveniently extend operating range. Today, this range is extended by employment of a hybrid self-contained, gas fueled, and motor-generating set. As battery technology increases storage capacity, the need for self-contained power generation decreases. This increases the operating range of the electric only operating mode. This extended range will have the effect of changing the operating mindset to that similar to gas fueled in that the deployment of ubiquitous electrical charging stations extends the vehicle operation thus becoming un-tethered from its home base. The un-tethered concern is mitigated by utilizing rule based diver recommendations on when and where to select a recharge station which is based on individualized driver preferences, such as convenience, cost avoidance, and environmental concerns.

### SUMMARY OF THE INVENTION

In accordance with one aspect of the invention, there is provided a computer system including display or voice and a means of driver data input within the Electric Vehicle for driver input, a flash memory that contains a unique private key in accordance with a-symmetrical encryption methods used to decrypt and verify trusted messages, a radio receiver used to detect geographic location and a radio transceiver used send and receive messages to and thru a connected Electric Vehicle.

In accordance with another aspect of the invention, there is provided an IP based wireless networked coupled to a server that contains individualized database and charge station geographic locations as well as the source of electricity for said charge stations and dynamic state of carbon content emissions associated with the source (i.e. utility).

In accordance with an additional aspect of the invention, there is provided a set of programmatic rules executing on the Electric Vehicle's computer and on the Server controlling when a connection is established between the Electric Vehicle, Network based Server and Database arrangement which is used to make decision recommendations regarding re-charging the Electric Vehicle's battery.

In accordance with a further aspect of the invention, a method is provided for forwarding and responding to Advertisement and a variety of purchasing options within the Electric Vehicle based on individualized database of operator profiles (preferences and demographic data), driving habits, Electric Vehicle's location, current battery condition and peak charge power, which determines charge time for the driver to choose.

The above summary of the present invention is not intended to describe each illustrated embodiment, or every implementation, of the present invention. This is the purpose of the figures and the detailed description which follow.

### BRIEF DESCRIPTION OF THE DRAWINGS

Other aspects and advantages of the invention will become apparent upon reading the following detailed description and upon reference to the drawings in which:

FIG. 1. Is a functional diagram of the Electric Vehicle recommendation system consistent with the principles of the present invention and shown coupled in communication to the IP Service Cloud.

FIG. 2. Is a functional block diagram of the key portions of the Electric Vehicle

FIG. 3. Is a flowchart illustrating the program flow of the top level process that drives autonomous recommendations and directed user request.

FIG. 4. Is a flowchart illustrating the program flow acquiring geographic location of the Electric Vehicle, User Data from a Server and forwarding Electrical Vehicle ID number and Geographic Location to the Server

FIG. 5. Is a flowchart illustrating the program flow acquiring geographic location of the Electric Vehicle, and finding the Distance (from a Server based Mapping utility or local navigation resource) to the Electric Vehicle Home Charge Station.

FIG. 6. Is a flowchart illustrating the program flow acquiring geographic location of the Electric Vehicle, and finding the Distance(s) (from a Server based Mapping utility or local navigation resource) to one or more Charge Stations.

FIG. 7. Is a flowchart illustrating the program flow acquiring the Battery Condition within the Electric Vehicle.

FIG. 8. Is a flowchart illustrating the program flow acquiring Advertisements from a Server database based on Electric Vehicle location and user preferences.

FIG. 9. Is a flowchart illustrating the program flow acquiring Promotional Offers from a Server database based on Electric Vehicle location and User Preferences and processing Promotional Offer response.

FIG. 10. Is the flowchart for illustrating the program flow for generating opportunistic Charging Offers for the Electric Vehicle user based on Battery Charge state, Location to Charge Station(s), Current Kilowatt cost and other User preferences, and processing Offer response.

FIG. 11. Is a flowchart illustrating the program flow for acquiring charge station data (location, cost, and power generation means) to recommend charge station options.

### DETAILED DESCRIPTION OF THE INVENTION

In the following detailed description numerous specifics are set forth in order to provide a thorough understanding of the present invention. However, the present invention may be used without understanding many of these specific details.

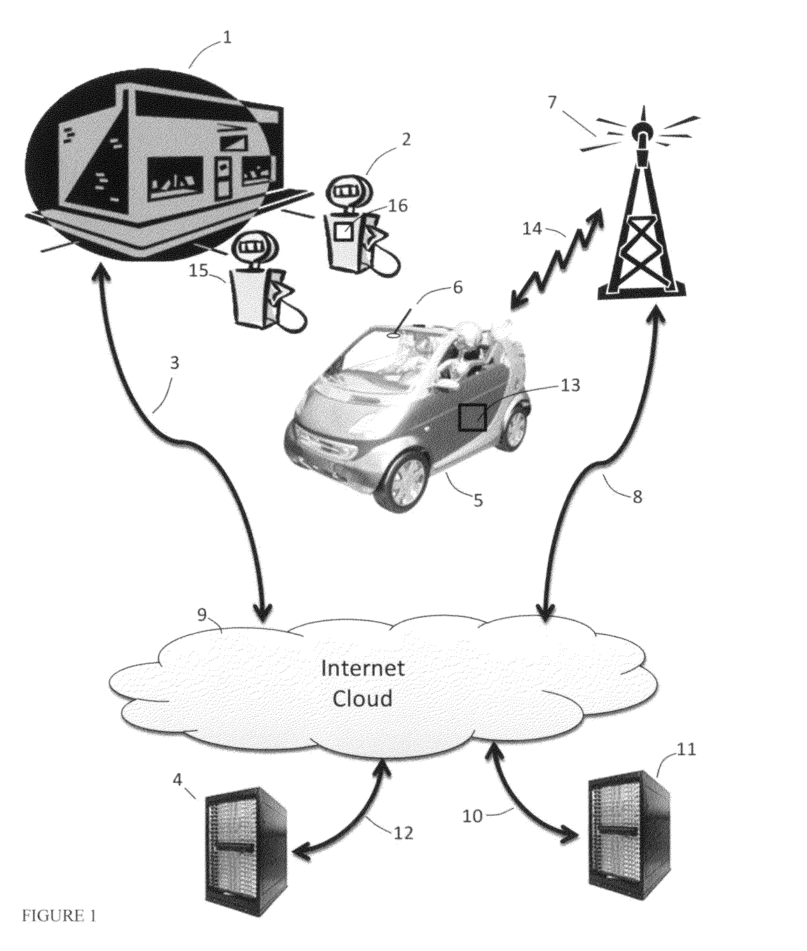

Turning to the drawings, FIG. 1 illustrates the Electric Vehicle 5 which contains a computer system and various control modules and radios 13. An antenna 6 facilitates wireless radio traffic of different types such as Wi-Fi, GPS and Cellular. The Cellular antenna 7 is shown in communication to Electrical Vehicle 5 forming an secure communication channel 14 which then continues to the Internet Cloud 9 to connect to Server 11 which contains an EV ROAM database (EV Roam Server) via connection 10

In another specific embodiment, the Store 1 (i.e. commercial retail business) which contains a computer system 15 is securely connected the Internet Cloud 9 by means of an IP connection 3 which allows access to the Server 4 that contains an Advertizing Database (Advertisement Server) by means of connection 12. The Advertisement Server makes ad inventory available to EV Roam Server 11 that contains unique personal and vehicle history via connections 12 and 10 for dynamic delivery of ads to the Electric Vehicle.

In an additional embodiment, based on predetermined parameters such as battery charge state, distance from the home base, distance to charge stations, running on Computer system 5 the Electric Vehicle will connect to the IP Server and request a charge event. Opportunistically based on current energy mix and or kilowatt cost of energy at specific charge stations within proximity of the Electric Vehicle, the IP Server will connect to the Electric Vehicle and suggest a charge event. On demand a user may request a charge event.

Another aspect of the invention provides a means with which the EV ROAM server initiates contact with the Electric Vehicle periodically based on user preferences for the purposes of gathering data to aid in making Proportional offers and or Battery Charge recommendations.

Another aspect of the invention provides a manner for aggregating and displaying the amount of carbon emissions associated with power generation means used to charge the Electric Vehicle over multiple charging events (i.e. carbon footprint), where in the information is displayed on the Electric Vehicle display and on an Internet portal site using information stored on the EV Roam Server and or a data storage device within the EV Roam module 13.

In an additional specific embodiment, information, characteristics, and statistics of Charge Station 2 may be published to the Electric Vehicle 5 from EV Roam Sever 11 by means of wireless communication based on the proximity of the Electrical Vehicle to the Charge Station 5 as determined by geographic location of the Electrical Vehicle and Charge Station 5 location data stored in EV Roam Server 11 which would be used to communicate pricing options and options based on power generation means (e.g. Solar Vs Coal) on the Electric Vehicles Computer Display and or the Charge Station's external display.

Another aspect of the invention provides a means for aggregating and displaying the amount of carbon emissions associated with power generation means used to charge the Electric Vehicle over multiple charging events (i.e. carbon footprint), where in the information is displayed on the Electric Vehicle display and on an Internet portal site.

As will be apparent from the description herein, an additional aspect of the invention provides a method of coupling a set of Advertisements based on personal profiles (e.g. demographic characteristics and preferences) of the driver as well as location of the Electrical Vehicle and current battery charge capacity state, by means of EV-Roam Server 11 coupled with Advertisement and location information contained in Advertisement Server 4.

Another aspect of the invention provides a manner for recommending a vehicle charge event in instances where a Charge Station 2 is commercially affiliated with a Retail Store 1 and offers a unique promotional offer based on this commercial affiliation, wherein the charge event recommendation also factors in user preferences based on power generation means (e.g. Solar Vs Coal) as well as other factors such as time of day rates, that are contained in the Electric Vehicle Driver's personal profile with EV-Roam Server 11.

Another aspect of the invention provides a manner for responding to advertisements with purchase decisions transacted through the Electric Vehicle display, where in an economic incentive is sent to the Electric Vehicles display based on pre arranged agreements between the Electric Vehicle Driver, a broker/agent of a retail establishment 1 and an advertisement delivery agent (Advertisement Server) 4 in combination of certain operational conditions and location of the Electric Vehicle 5.

Each of these aspects will be discussed in greater detail herein. However, it should be appreciated that each aspect of the invention may be implemented separate of the other in specific embodiments of the invention.

Specific embodiments which implement this aspect of the invention generally operate by utilizing multiple processing elements interfaced to each other using multiple communication radios utilizing a-symmetrical public key encryption algorithms to encrypt all data which travel over the public access communication channels. Enabling Public Key Infrastructure uses Public Key Certificates issued by a Certificate Authority that establishes the chain of trust between the Charge Station and the Electric Vehicle which is administrated by the Authentication Server which contains the Certificate Authority.

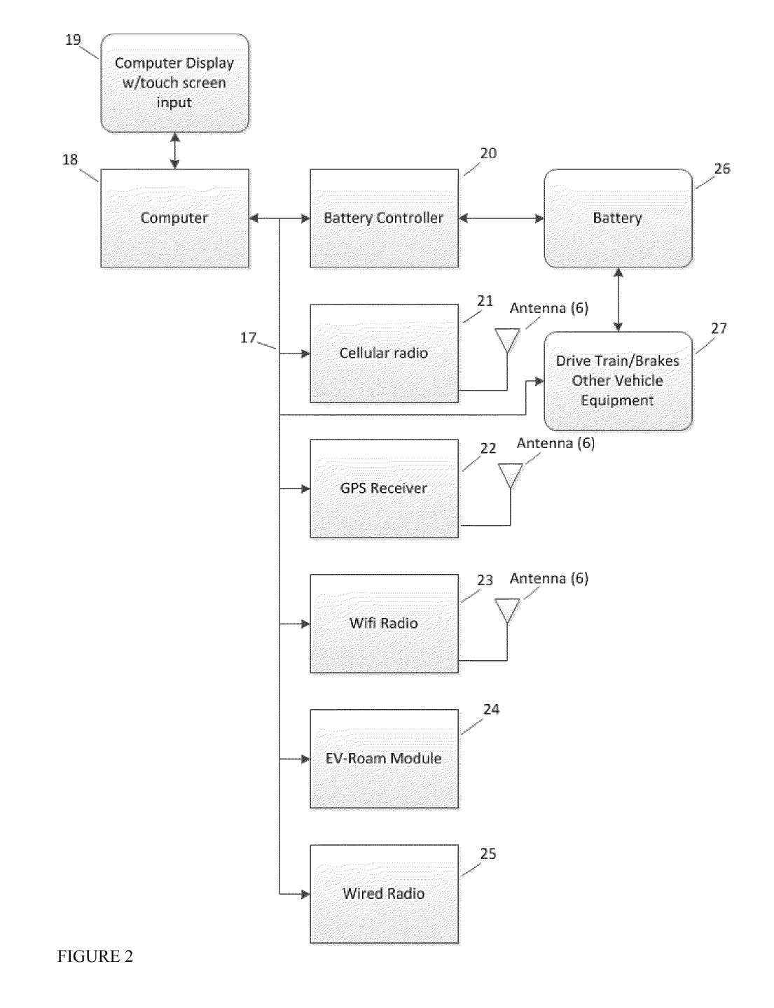

FIG. 2 illustrates a specific embodiment of the major modules that are contained within the Electric Vehicle which includes a common bus (e.g. Can-Bus) 17 that provides communication between the Battery Controller 20 used to acquire the current Battery charge condition, Cellular Radio 21 used to establish secure IP communication to the Internet Cloud 9 and triangulation location, GPS Receiver 22 used to acquire Latitude and Longitude data, WiFi Radio 23 used for short range communication to Charge Stations, EV-Roam module 24 used to store security codes, user data, and EV-Roam specific hardware, Wire-Line Radio 25 used to communicate to a Charge Station using the Charging Cable, Drive Train/Brakes 27 which represents the rest of the Electric Vehicle equipment package, and the Computer 18 used to execute specific programs, drive Display acquire user response on Touch Screen 19.

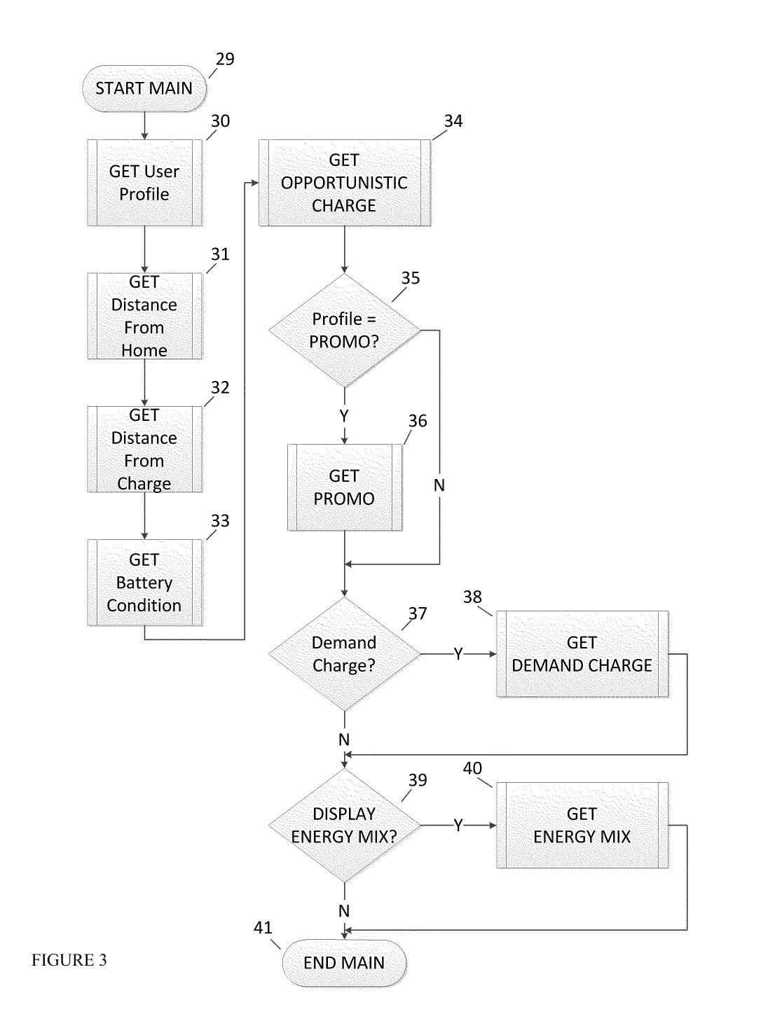

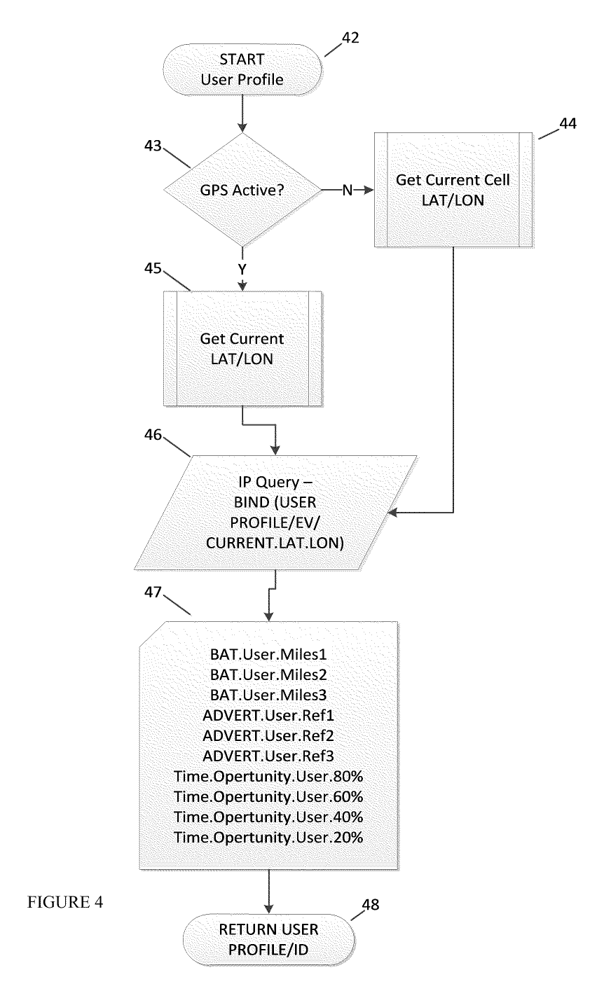

Referring to FIG. 3 illustrates the top level program flow that coordinates information to and from each additional program routine as illustrated in FIGS. 4,5,6,7,8,9,10,11 and 12. The execution of this flow is periodic based on internal timers and external events (i.e. Touch Screen commands). Entry (from initial Electric Vehicle Startup) is Start Main 29 that calls Get User Profile Routine 30 which refers to FIG. 4.

FIG. 4 illustrates a process where the GPS receiver is tested for activity 43 followed by a query 45 which returns Longitude and Latitude location data. If the GPS is not active (not receiving Satellite telemetry, Cellular triangulation is used 44 to return a more course geographic location. Once the location is obtained, a query message to “GET USER PROFILE” with the Electric Vehicle ID and User ID from the ignition circuit is sent via a secure cell phone data service to the EV-Roam Server which returns specific Electric Vehicle historical data and specific User profiles 47. This information is forwarded to the Top level execution program 48.

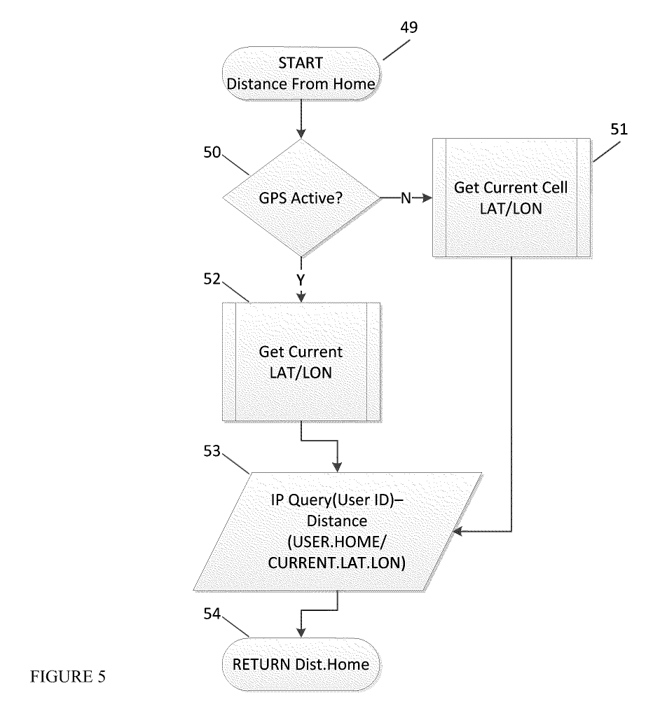

Referring back to FIG. 3, the next routine called is Get Distance from Home 31 which refers to FIG. 5.

FIG. 5 illustrates a process where the GPS receiver is tested for activity 50 followed by a query 52 which returns Longitude and Latitude location data. If the GPS is not active (not receiving Satellite telemetry, Cellular triangulation is used 51 to return a more course geographic location. Once the location in obtained, a query message to “Get DISTANCE TO HOME” from the current location to the registered Electric Vehicle's home location (located in the EV-Roam Server) is sent via a secure cell phone data service to the EV-Roam Server which then queries a mapping utility and returns the distance needed to travel to return home. This information is forwarded to the Top level execution program 54

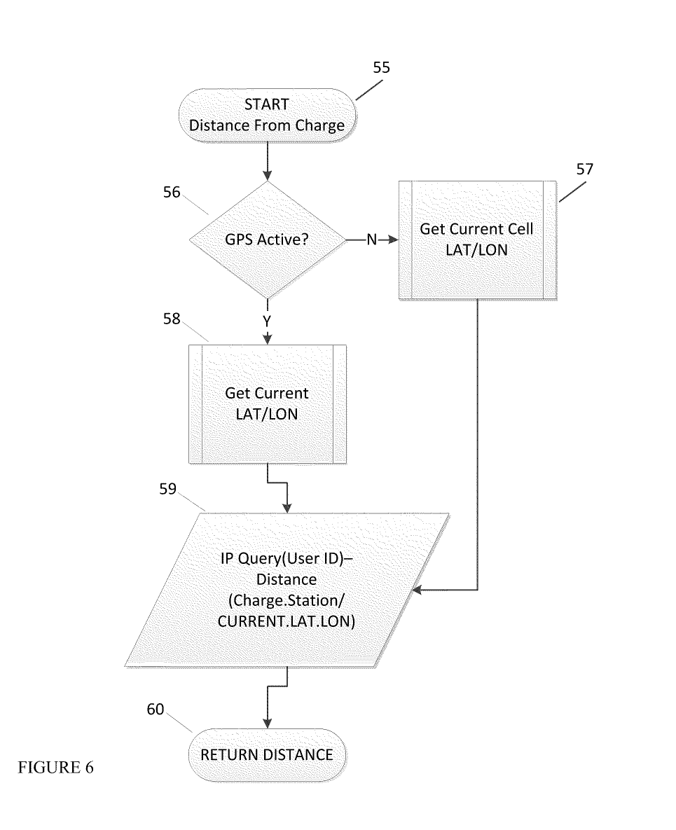

Referring back to FIG. 3, the next routine called is Get Distance from Charge 32 which refers to FIG. 6.

FIG. 6 illustrates a process where the GPS receiver is tested for activity 56 followed by a query 58 which returns Longitude and Latitude location data. If the GPS is not active (not receiving Satellite telemetry, Cellular triangulation is used 57 to return a more course geographic location. Once the location in obtained, a query message to “Get DISTANCE TO Charge Station” from the current location is sent via a secure cell phone data service to the EV-Roam Server which then queries a mapping utility and returns the a list of Charge Stations and Distance from present location. This information is forwarded to the Top level execution program 60

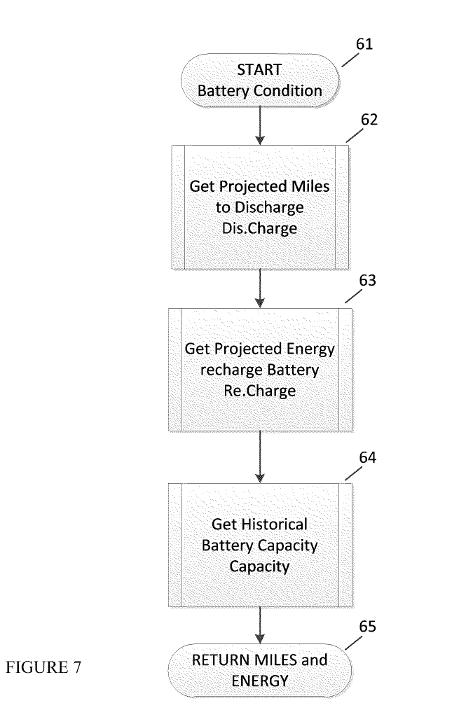

Referring back to FIG. 3, the next routine called is Get Battery Condition 33 which refers to FIG. 7.

FIG. 7 illustrates a process, where the Computer 18 in FIG. 2, queries the Battery Controller 20 in FIG. 2, which monitors the current Battery Charge and Discharge Rate of Battery 26 in FIG. 2, which can then project the number of miles left to drive before Battery 26 in FIG. 2 is, exhausted of Charge. This value is Projected MILES 62. Block 63 represents a an additional query from Computer 18 in FIG. 2, which obtains the current Battery Charge Capacity 64 which is then used to project the energy to re-charge the battery 63. This information is forwarded to the Top level execution program 66

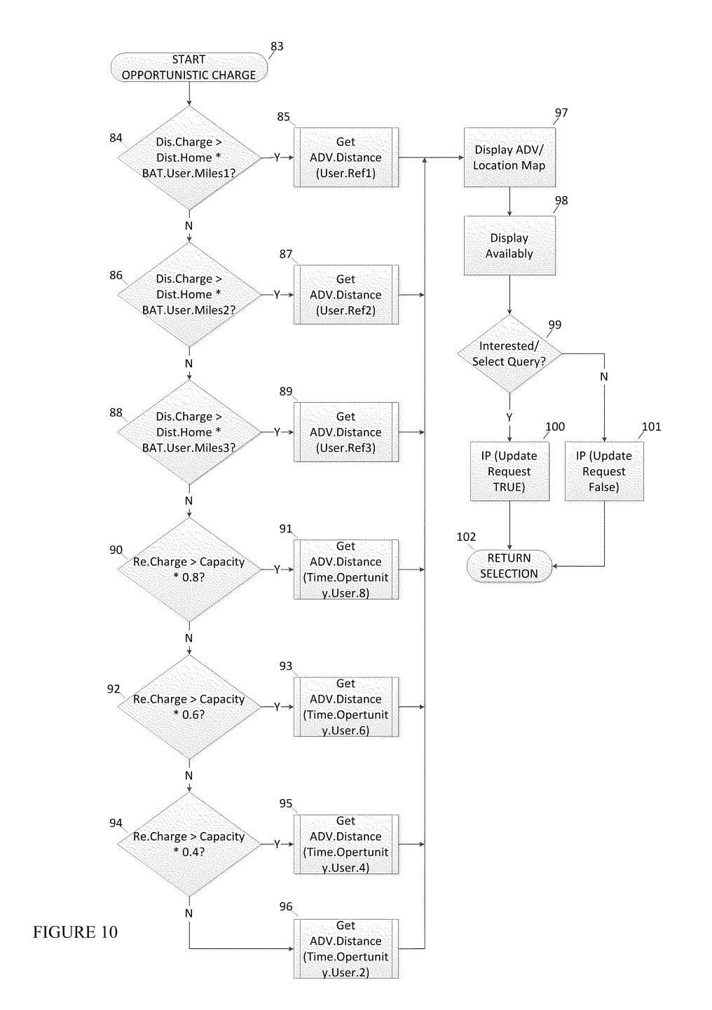

Referring back to FIG. 3, the next routine called Get Opportunistic Charge 34 which refers to FIG. 10.

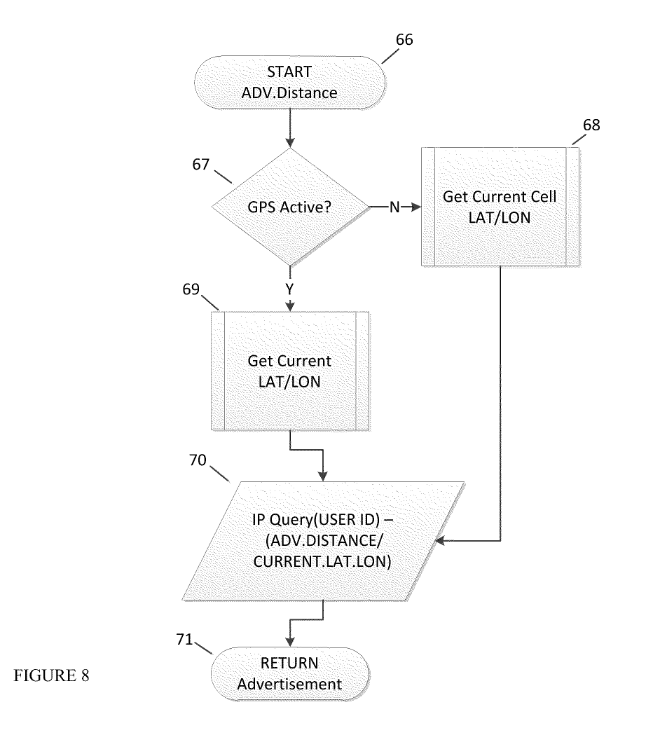

FIG. 10 illustrates a process, where the Computer 18 in FIG. 2, executes a sequence of decisions (rules) represented by 84, 86 and 88, which sequentially checks the Distance to a Charge Station with Distance from Home times a user profile factor to determine circles of distance where Advertisements/Charge Stations are requested by 85,87 and 89 respectively, referring to FIG. 8, which are send the Computer Display and Touch Screen 19 in FIGS. 2, 97 and 98 for a response to the Advertisement and or Charge Offer query 99, with which a true (accepted) 100, false (rejected) 101 is forwarded by an IP message to the Advertisement Server 4 in FIG. 1.

FIG. 10 also illustrates a process, where the Computer 18 in FIG. 2, executes a sequence of additional decisions (rules) represented by 90, 92, 94 which sequentially checks the Distance to a Charge Station existing Batter Charge Capacity to determine circles of distance where Advertisements/Charge Stations are requested by 91, 93, 95 and 96 respectively, referring to FIG. 8, which are send the Computer Display and Touch Screen 19 in FIGS. 2, 97 and 98 for a response to the Advertisement and or Charge Offer query 99, with which a true (accepted) 100, false (rejected) 101 is forwarded by an IP message to the Advertisement Server 4 in FIG. 1.

Referring to FIG. 8, illustrates a process where the GPS receiver is tested for activity 67 followed by a query 69 which returns Longitude and Latitude location data. If the GPS is not active (not receiving Satellite telemetry, Cellular triangulation is used 68 to return a more course geographic location. Once the location in obtained, a query message to “Get Advertisement” based on distance available to Charge Station from the current location is sent via a secure cell phone data service to the EV-Roam Server which then queries a mapping utility and returns the a list of Charge Stations and Distance from present location 70. This information is forwarded to the Top level execution program 71

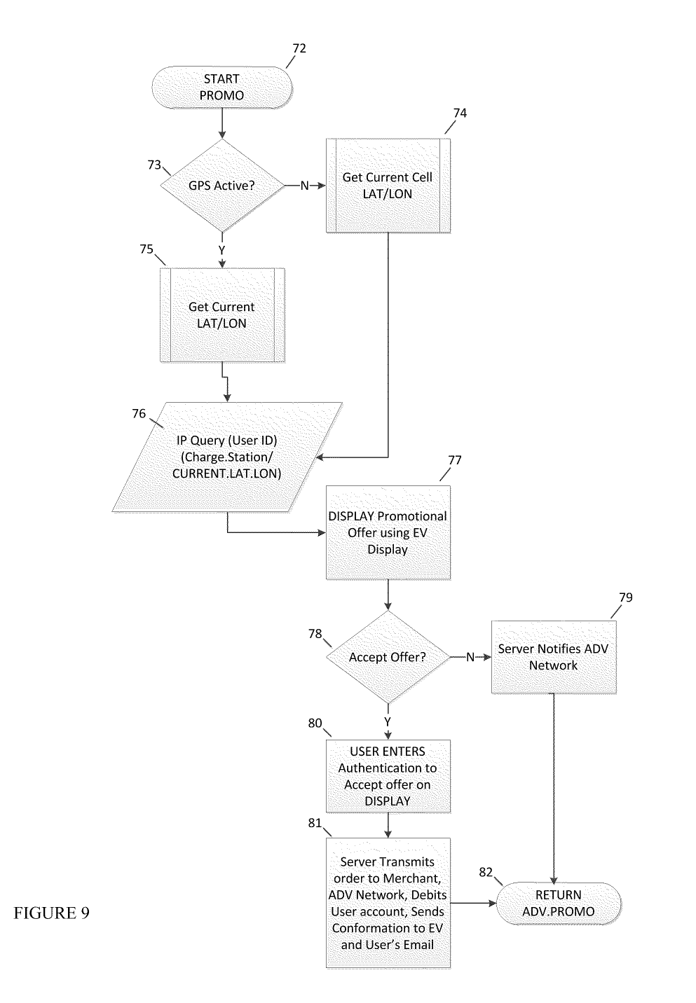

Referring back to FIG. 3, if the user profile allows Promotional Offers 35, then the next routine called Get Promo 36 which refers to FIG. 9.

FIG. 9 illustrates a process where the GPS receiver is tested for activity 73 followed by a query 75 which returns Longitude and Latitude location data. If the GPS is not active (not receiving Satellite telemetry, Cellular triangulation is used 74 to return a more course geographic location. Once the location in obtained, a query message to “Promotional Offers based on User ID from the current location is sent via a secure cell phone data service to the EV-Roam Server and Advertisement Server which then queries a mapping utility and returns the a list of Promotions from present location. This information is then forwarded to the Computer Display 19 in FIGS. 2, 77, and 78 where an offer is accepted with Authentication 80 which is then processed 81 or Rejected 79.

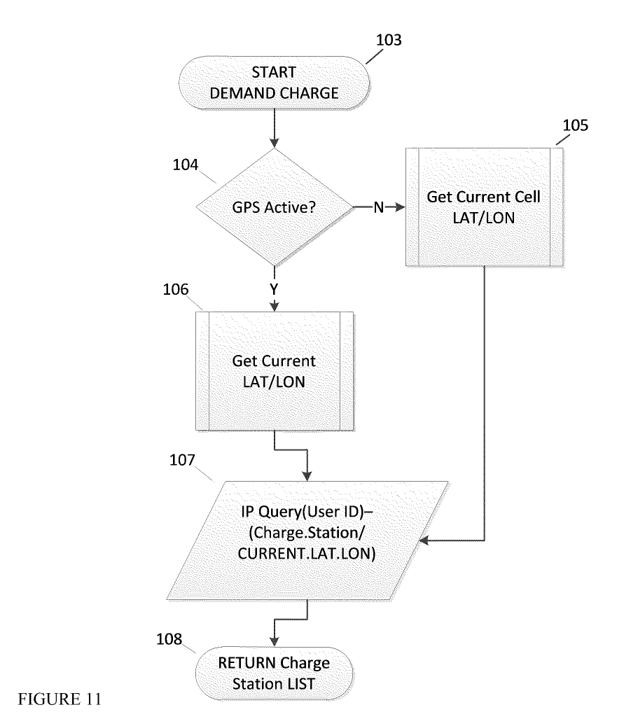

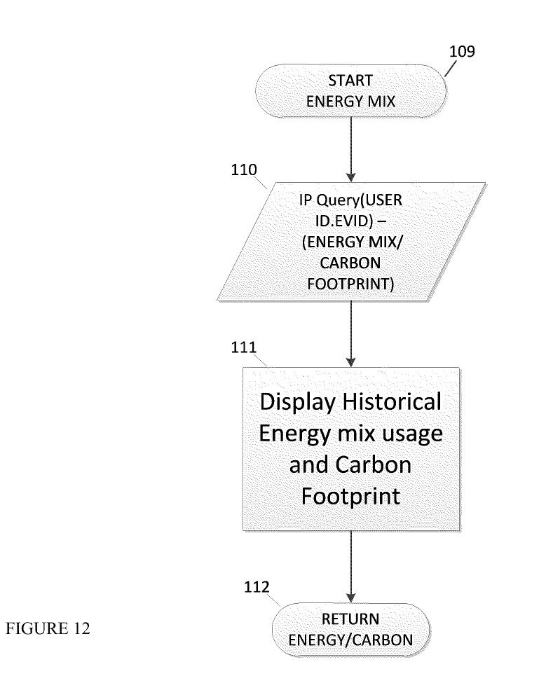

Referring back to FIG. 3, if the user initiates a query to find Charge Stations 37, a Get Demand Charge routine is executed 38 which refer to FIG. 11.

FIG. 11 illustrates a process where the GPS receiver is tested for activity 103 followed by a query 105 which returns Longitude and Latitude location data. If the GPS is not active (not receiving Satellite telemetry, Cellular triangulation is used 104 to return a more course geographic location. Once the location in obtained, a query message to “Get DISTANCE TO Charge Station” from the current location is sent via a secure cell phone data service to the EV-Roam Server which then queries a mapping utility and returns the a list Charge Stations and Energy Mix profiles and Distance from present location 107. This information is forwarded to the Top level execution program 108.

Referring back to FIG. 3, if the user wants to display the Energy Mix 39, a GET ENERGY MIX routine is executed 40 which refers to FIG. 12

FIG. 12 illustrates a process where a query message to “Get Energy and Carbon Footprint” information is sent via a secure cell phone data service to the EV-Roam Server which then returns Historical energy mix usage and Carbon Footprint data based on User ID and EVID information. This information is forwarded to the Display 19 in FIG. 2 and is forwarded to the Top Level execution program

1) A system comprising:
a. Electric Vehicle including: geographic location device, Wireless network radio, battery state meter, power consumption meter, clock, Unique ID, Computer processor and display, home location.
b. IP Based network database including: geographic locations of charge stations, current state of charge stations, Time of day power cost, local Advertising offset revenue.
c. Pre established reference location associated with the Electric Vehicle such as a home or business
d. A plurality of Charge-Stations with pre defined geographic locations stored in a remote database

2) The system of claim 1 wherein a secure communication session is established between the Electric Vehicle and the IP based network initiated by the Electric Vehicle or the IP Server based on the user's predefined rules, or at anytime at the user's discretion.

3) The system of claim 2 wherein the Electric Vehicle establishes a charge demand based on driving history and existing battery capacity.

4) The system of claim 3 wherein the Electric Vehicle sends battery condition and capacity and geographic location to the IP based network.

5) The system of claim 4 wherein the IP based network database compares a plurality of parameters including but not limited to distance traveled; home location; battery charge status; discharge history; time of day recharge rate; available charge stations within a defined proximity; energy mix of referenced charge stations with the current optional rates for charge and makes a recommendation for a charge event which may be supplemented by Advertisement and or promotion

6) A system comprising:
a. Electric Vehicle including: geographic location device, Wireless network radio, battery state meter, power consumption meter, clock, Unique ID, Computer processor and display, home location.
b. IP Based network database including: geographic locations of charge stations, current state of charge stations, Time of day power cost, locus of Advertising offset revenue.
c. Charging station including: a power source; pre-defined re-programmable security certificate containing a unique ID; a connection cable; an access control communication processor; a wire line communication link; a wireless connection radio; a switch to connect the power source to the cable.

7) The system of claim 6 wherein the Electric Vehicle establishes a secure wireless communication session to the IP based network.

8) The system of claim 7 wherein the Electrical Vehicle exchanges status information of the Electric Vehicle and Charge Station with the IP based network database.

9) The system of claim 8 wherein the electrical Vehicle displays charge cost options and energy mix options (i.e. carbon content of electricity generation fuel) on a computer display for the operator to select

10) The system of claim 9 therein the IP based network sends an advertisement based on the location and time of day to the computer display.

11) A method of distributing advertizing comprising:
a. Electric Vehicle including: geographic location device, Wireless network radio, battery state meter, power consumption meter, clock, Unique ID, Computer processor and display, home location.
b. IP Based network database including: geographic locations of charge stations, current state of charge stations, Time of day power cost, locus of Advertising offset revenue.

12) The method of claim 11 wherein the server system pushes a consent form to the client system enabling the electric vehicle owner operator to “opt in” to a personalized advertising and commerce fulfillment service using their vehicle location and the owner-operators' behavior and preferences.

13) The method of claim 12 wherein the server system pushes advertisements or promotional offers to the electric vehicle's display for products and services that may be related or unrelated to electric vehicle charging or vehicle's geographic location.

14) The method of clam 13 wherein the server system uses the receiving component of the system to receive responses to advertisements and pushes a screen wherein the electric vehicle owner-operator must enter a personal identifier number using the touch screen display in the electric vehicle to verify personal identity.

15) The method of claim 14 wherein the server system uses the billing fulfillment component to acknowledge the response to advertising and fulfills the order for the selected products or services and stores all records of the transaction within the data storage medium.

16) The method of claim 12 wherein the server system categorizes electric vehicle owner operators into specific targeting categories based on preferences as provided from the user and/or inferred from past responses to advertising responses stored in the data storage medium of the server system.

17) The method of claim 11 wherein the server system determines the amount of time that will be needed to re-charge the electric vehicle and informs the electric vehicle operator using the vehicle's computer display.

18) The method of claim 11 wherein “energy mix” information is obtained from the affiliated electric service utility; “energy mix” represents the proportional mix of energy sources used by the utility to generate the electricity provided through the charge station to charge the electric vehicle's batteries during the charge event; the energy mix includes but is not limited to the following energy: hydrocarbon (coal, natural gas, and other hydrocarbon), nuclear, clean renewable (hydro, wind, solar and other non-hydrocarbon based renewable energy sources).

19) The method of claim 18 wherein the energy mix information is displayed on charge station (if it is equipped with a display) and the electric vehicle onboard display.

20) The method of claim 19 wherein the energy mix information is aggregated for each electric vehicle to create a unique “energy usage profile” for the vehicle. The energy usage profile is updated immediately after the completion of each charge event to reflect the cumulative amount of energy charged during all charging events defined according to the energy mix categories and also includes a calculation of the vehicle's carbon footprint, i.e. the total amount of carbon dioxide (CO2) emissions created by the power utility when hydrocarbon fuel sources were used to generate the electricity used to recharge the vehicle's batteries.

21) The method of claim 20 wherein the energy usage profile information can be parsed and calculated to represent energy usage for a number of different timeframes, including but not limited to: the life of the vehicle, the past year, the past six months, the past month, etc.

22) The method of claim 21 wherein the energy usage profile is displayed on the Electric Vehicle display in both graphical and numeric formats and published via the Internet, other digital media, and printed hardcopy material.

23) The method of claim 22 wherein the energy usage profile can enable a given electric vehicle energy usage profile to be compared and contrasted with the average profiles based on the aggregated data of various groupings (or “communities”) of electric vehicle owners, including but not limited to groupings by geography, vehicle make, vehicle model, or various demographic characteristics of electric vehicle owner-operators, such as age, gender, income, education, driving record, and other attributes.
